(19) United States
(12) Patent Application Publication
(10) Pub. No.: US 2012/0068660 A1
(43) Pub. Date: Mar. 22, 2012

(54) OPERATION METHOD OF POWER TRANSMISSION AND DISTRIBUTION SYSTEM USING SECONDARY BATTERY

(76) Inventors: Takashi AIHARA, Hitachinaka (JP); Shinichi Inage, Hitachi (JP); Isao Wachi, Hitachi (JP); Masahiro Watanabe, Hitachi (JP)

(21) Appl. No.: 13/195,080

(22) Filed: Aug. 1, 2011

(30) Foreign Application Priority Data
Aug. 4, 2010 (JP) 2010-174988

(51) Int. Cl. H02J 7/00

(52) U.S. Cl. 320/101

(57) ABSTRACT

A battery-used power grid operation method for handling a home-use secondary battery as a virtual battery of medium- to large-scale and for lessening a necessary cell capacity to thereby enable efficient absorption of an output variation of renewable energy-derived electric power is provided. In a power system including electrical household appliances in a house having a renewable power generator, an individual house-installed rechargeable battery or separately central-managed battery, and a control device which measures and controls an output variation of the renewable power generator, those output variations of the renewable power generator occurring with time and due to changes of weather and seasons are absorbed as much as possible by preset-temperature control of the electric household appliances in the house while absorbing the remaining variations by charge/discharge of the battery, thereby lessening an electricity storage capacity required for the variation absorption.

### BACKGROUND OF THE INVENTION

The present invention relates to a battery-used grid operation method adapted for an electrical power transmission/distribution system having a plurality of scale-different renewable energy power generators and an electricity secondary battery.

Prior known techniques include one disclosed in JP-A-2003-309928, which provides a non-commercial electrical power source that consists essentially of a private power generation device of the type using natural resources, such as a solar photovoltaic (PV) power generator, wind-force power generator or the like, an electricity storage device that stores surplus electric energy, a power meter that monitors an output of the non-commercial power source, a power meter that monitors input/output of the electricity storage device, and a control device for providing control to lessen, when electric power supplied to a load runs short, the load in accordance with the current states of the non-commercial power source and the electricity storage device.

### SUMMARY OF THE INVENTION

The prior art disclosed in the above-cited Japanese patent literature is the one that controls to reduce the load in accordance with states of the non-commercial power source and electricity storage device when power being fed to the load goes short; however, it fails to take into consideration a point which follows.

Whereas the cost needed for wind power generation is 1,500 U.S. dollars/kW (inspected in 2009), the cost of a secondary battery is 5,000 USD/kW, which is three or more times greater than the cost for the wind power generation. For this reason, it is desired to put into practical use a technique for lessening the necessary capacity of such battery.

An object of this invention is to provide a battery-used power grid operation method for operating a home-use secondary battery as a virtual battery of medium- to large-scale and for enabling efficient absorption of an output fluctuation or variation of renewable energy power generator while lessening the cell capacity required therefor.

To attain the foregoing object, the power grid operation method according to the present invention, which is adaptable for an electricity distribution system of a house having a renewable energy power generator, wherein the system is configured from a home-use electrical equipment in the house, an individual house-installed or separately central-managed secondary battery system, and a control device for measuring an output variation of the renewable power generator and for controlling the output variation, is comprised of absorbing an output variation of house-oriented small-scale renewable power generator occurring due to changes in time and weather and changes of seasons to a maximum extent by preset temperature control of home-use electric equipment, which is free from the risk of losing the convenience of life due to a short time change, and absorbing the remaining variations by charge and discharge of the secondary battery.

In addition, the power grid operation method according to the present invention, which is adapted for a system including electric power-demanding devices within demand-side structures that are larger in scale than houses, such as buildings, factories and large warehouses, an individual house-installed or separately central-managed secondary battery system, and a control device which measures an output variation of a renewable energy power generator and controls the output variation, is comprised of absorbing an output variation of a renewable power generator placed in an electrical power transmission/distribution system occurring due to changes in time and weather and changes of seasons as much as possible by preset temperature control of electric power-demanding devices of buildings, factories and large warehouses, which equipments are free from the risk of losing the convenience of life due to a short time change, and absorbing a remaining variation by charge and discharge of a virtual large-size secondary battery utilizing a plurality of power storage capacities to thereby absorb variations of the large-scale renewable power generator interconnected to the electric power transmission/distribution system.

Further, the power grid operation method according to the present invention, which is for use in an electrical power transmission system having a large-scale renewable energy power generator whose output power is capable of being supplied to a group of houses and also to a plurality of buildings, factories, large warehouses and like building structures, wherein the system is generally made up of a thermal power generation station, a virtually central-managed secondary battery, and a control device for measuring an output variation of a renewable power generator and for controlling the output variation, is comprised of absorbing output variations of the renewable power generator placed in the power transmission system occurring due to changes in time and weather and changes of seasons are absorbed as much as possible by adjustment of an output of thermal power generation station, and absorbing the remaining variations by using a plurality of power storage capacities and by leveraging them as a virtual large-size battery to thereby absorb variations of one or more than one large-scale renewable power generator interconnected to the power transmission system.

According to this invention, it is possible to reduce the secondary battery capacity required for the renewable energy variation absorption and to remove power output variations, thereby enabling achievement of stable supply/distribution of electric power.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a power grid using a secondary battery in accordance with an embodiment 1 of this invention.

FIG. 2 is a diagram showing an output variation.

FIG. 3 is a diagram showing an output variation.

FIG. 4 is a diagram showing an output variation.

FIG. 5 is a diagram showing a power grid using a secondary battery in accordance with an embodiment 2 of this invention.

FIG. 6 is a diagram showing a power grid using a secondary battery in accordance with an embodiment 3 of this invention.

### DESCRIPTION OF THE EMBODIMENTS

Respective embodiments of this invention will be described with reference to the accompanying drawings.

### Embodiment 1

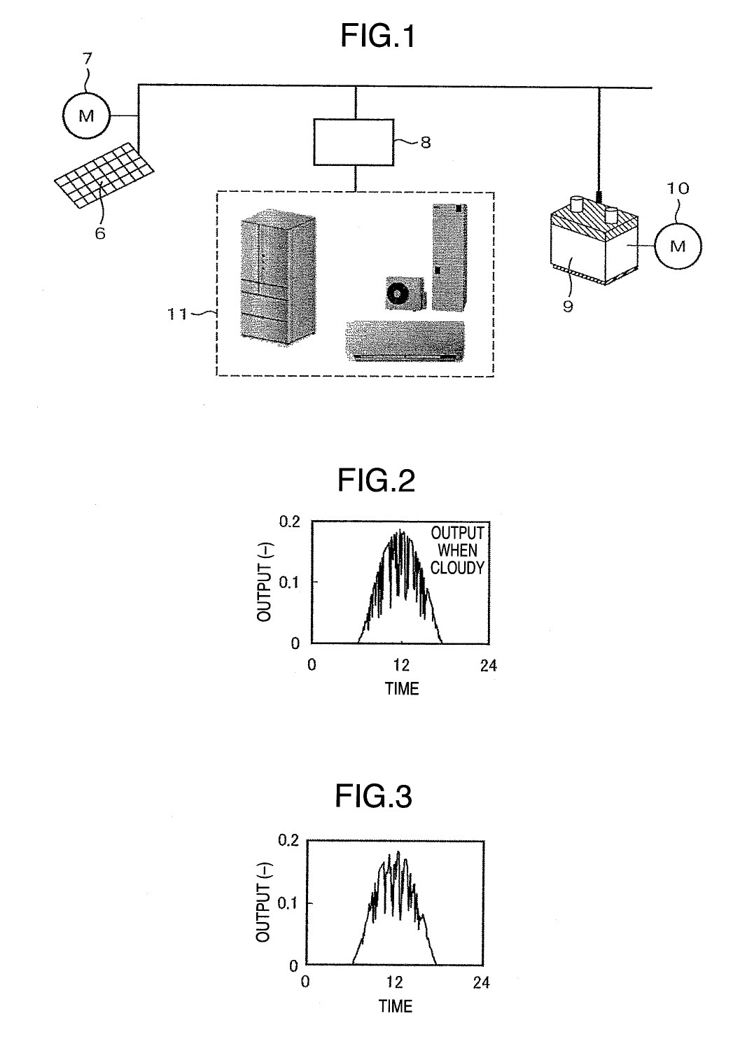

An embodiment 1 of this invention will be explained by using FIGS. 1 to 4. FIG. 1 is a diagram showing a power grid using an electricity secondary battery.

In this embodiment, a solar photovoltaic (PV) power generation device 6 is installed on the roof of a house as one example of a home-use renewable energy. Connected to the solar power generator device 6 is a first monitoring device 7 which measures an output of the solar power generator 6 and an output fluctuation or variation thereof. The solar power generator 6 is connected to a control device 8 which is operatively responsive to receipt of measurement data of the output and output variation of solar power generator 6, for controlling respective ones of electrical household appliances and home-use electric equipment 11 in the house, which are connected to the control device 8. The control device 8 is also connected to a secondary battery 9, and a second monitoring device 10 which measures an electricity storage capacity of the battery 9.

The solar power generator device 6 can experience occurrence of a large output variation in cases where the sunlight is blocked by clouds opportunistically. The monitoring device 7 operates to measure an average output and an output variation of the solar power generator 6 and send its data to the control device 8. The control device 8 controls the electric household appliances 11 in the house—for example, temperatures of a refrigerator and an air conditioner, a temperature of a hot-water supplier or flow rate adjustment thereof, etc. within a range in which the convenience is not affected thereby.

The convenience of life is not lost even when the refrigerator and air conditioner in the house are changed in temperature for a short period of time; so, a variation of small-scale renewable power generator, such as the solar power generator device 6 for home use, is absorbed within the realm of possibility by controlling the preset temperature of the electric household appliance/equipment 11.

The monitor device 7 is measuring an output of the solar power generator device 6 and an output variation thereof, and sends its measurement data to the control device 8. In response to receipt of the data, the control device 8 provides control in a way which follows: when the output of the solar power generator 6 decreases, the control device 8 allots such output variation to the electric household equipment 11, and calculates an increment of the preset temperature, and then reconfigures the preset temperature. In a case where the output of the solar power generator 6 increases, the control device 8 provides control in such a way as to allot an output variation of it to the electric household equipment 11 and calculate a decrement of the preset temperature in a contrary manner and then reconfigure the preset temperature.

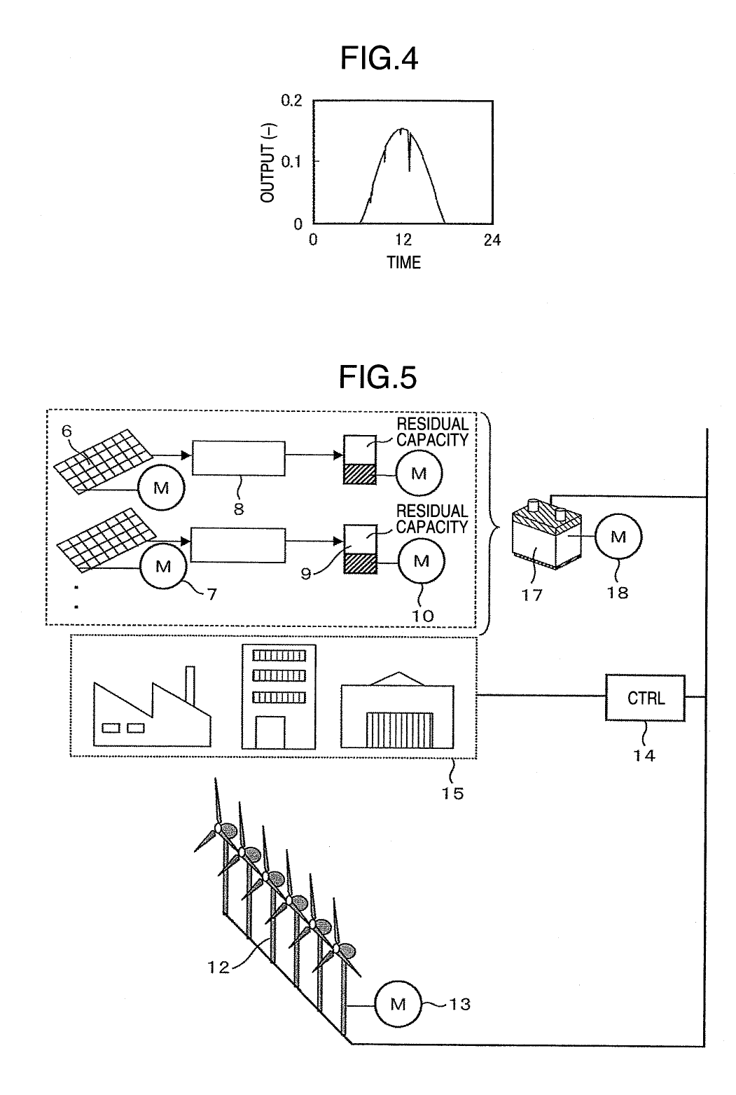

With this control, the variation of the output from the solar power generator device 6 is reduced as shown in FIGS. 2 and 3. Although a certain degree of output variation remains as shown in FIG. 3, the monitor device 10 is monitoring the capacity of the secondary battery 9; so, by controlling charge/discharge of the battery 9 placed in the house or a separate one under central management to thereby absorb the remaining output variation, it becomes possible to control a major variation to an extent that it does not affect the power grid as shown in FIG. 4. In this way, the battery 9 performs a charge-up operation in cases where the output variation is in excess of the average output and, adversely, performs discharge when the output variation is less than the average output, thereby acting to absorb such output variation.

According to the embodiment 1, it is possible to lower the battery capacity required for absorption of output variations of the home-use renewable power generator. This makes it possible to absorb output variations of the home-use renewable generator, thus enabling stable supply of electric power.

### Embodiment 2

An embodiment 2 of this invention will be described with reference to FIG. 5. FIG. 5 is a diagram showing a power grid using a secondary battery of this embodiment. A solar power generation device 6 is placed on the roof of a house as one example of the home-use renewable energy power generator. The solar power generator device 6 is operatively associated with a first monitoring device 7 connected thereto, which measures an output and an output variation of the solar power generator 6. The solar power generator 6 is also connected to a control device 8 which controls respective one of presently connected electrical household appliances and equipment 11 in response to receipt of measurement data to be sent from the monitor device 7 indicating an output and output variation of the solar power generator 6. The solar power generator 6 is further connected to a secondary battery 9 and a second monitoring device 10 which measures a heat storage capacity of the battery 9. Although not specifically illustrated in FIG. 5, the control device 8 is associated with electric household appliances and equipment 11 in the same manner as the embodiment 1 stated supra. Note here that a plurality of secondary batteries 9 are managed as a virtual battery 17 (also referred to as virtual medium-scale secondary battery 17) with its capacity corresponding to an aggregation of residual quantities of small-size secondary batteries. Connected to this virtual battery 17 is a third monitoring device 18 which is measuring a cell capacity of the battery 17.

On the other hand, a wind power generator 12 is installed as one example of a large-scale renewable energy power generator. This wind power generator 12 is connected to a fourth monitoring device 13 which measures an output and an output variation of the wind power generator 12.

The wind power generator 12 is operatively associated with a control device 14 connected thereto, which is responsive to receipt of measurement data of the monitor device 13 indicating an output and output variation of the wind power generator 12, for controlling electric power-demanding devices 15 such as large-size freezing chambers and central air conditioners installed in buildings, factories and large warehouses.

At the wind power generator 12, there can take place an output variation with time and an output variation due to a change in weather and changes of seasons. The monitor device 13 measures an average output and output variations, and sends its measurement data to the control device 14. In responding thereto, the control device 14 controls temperatures of the electric power-demanding devices 15, e.g., the large-size freezing chambers, the centrally controlled air conditioners 16 and others, within the range that the temperature control does not affect the convenience of industrial-use electric machines in the buildings, factories and large warehouses existing in the power grid.

When it is determined from the measurement data sent from the monitor device 13 that the wind power generator 12 is lowered in output power, the control device 14 provides control in such a way as to allot such output variation to the electrical power-demanding devices 15 of buildings, factories and large warehouses to thereby reduce the energy of each electric power-demanding device. When it is judged from the measurement data sent from the monitor device 13 that the output of wind power generator 12 increases, the control device 14 provides control in a way as to allot such output variation to the electric power-demanding devices 15 of buildings, factories and large warehouses, thereby increasing, conversely, the energy of each electric power-demanding device.

In this way, the wind power generator 12 is lessened in its output variation by allotting it to the electrical power demanding devices 15 of buildings, factories and large warehouses in accordance with a decrease or an increase in output power of the wind power generator 12 to thereby control in a way that the power demanding devices 15 decrease or increase in energy.

The monitor device 18 is monitoring a present capacity of the virtual secondary battery 17. The remaining variation is absorbed by the virtual large-size battery 17 with its capacity corresponding to an aggregation of residual capacities of in-home-installed secondary batteries 9 or separately central-managed ones, thereby making it possible to control the main power variation or fluctuation to the extent that no appreciable influence is exerted on the grid per se.

According to the embodiment 2, it is possible to reduce the secondary battery capacity necessary for the absorption of a variation of renewable energy-derived electric power capable of being supplied to the buildings, factories and large warehouses, thereby enabling removal of output variations. Thus, it becomes possible to stably supply electric power. Especially, installation of any new secondary battery is not needed. This makes it possible to gather residual capacities of the secondary batteries as have been explained in the embodiment 1 and then to leverage them as a virtual large-size secondary battery.

Also importantly, because of the fact that the electric power storage capacity required is made smaller than the amount of output variation absorption owing to the electric power demanding device, the secondary battery capacity is expected to have an adequate residual quantity. Furthermore, gathering such residual quantities makes it possible to leverage the resulting one as a virtual large-size secondary battery with its capacity large enough to enable absorption of output variations of the large-scale renewable power generator.

### Embodiment 3

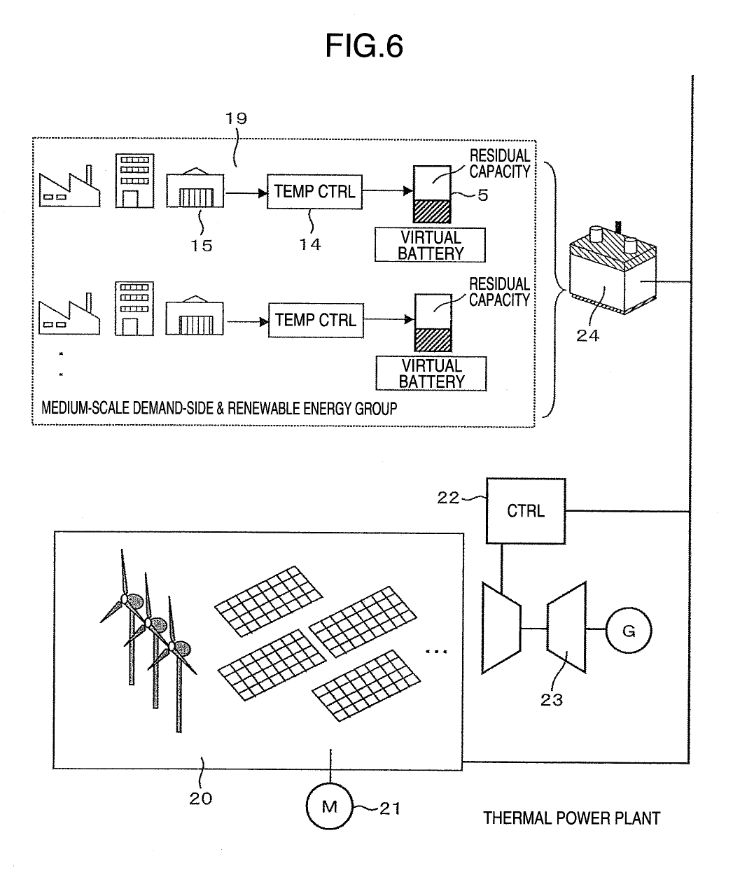

An embodiment 3 of this invention will be described with reference to FIG. 6. FIG. 6 is a diagram showing a power grid using a secondary battery of this embodiment.

Reference numeral 19 designates a medium-scale demanding group with a plurality of secondary batteries 5, each of which is connected to the control device 14 and the electrical power-demanding devices 15 installed in buildings, factories and large warehouses, which have been explained in the embodiment 2. These secondary batteries 5 are managed as a virtual secondary battery 24 having its capacity corresponding to gathered residual capacities of the secondary batteries.

Numeral 20 denotes a large-scale renewable energy power generation apparatus including wind and solar power generators. A monitor device 21 which is coupled to the large-scale renewable power generator 20 is measuring an output power and an output variation of the renewable power generator 20. For example, the wind power generator is connected to an electric power transmission line by way of a converter and voltage-boosting transformer (not shown in FIG. 6), and also connected to a thermal power plant 23.

The thermal power plant 23 is connected to a control device 22, which receives measurement data from the monitor device 21 and controls the thermal power plant 23.

At the large-scale renewable power generator 20 there can occur an output variation with time and/or output variations due to changes of weather and seasons. The monitor device 21 measures an average output and output variations and sends its measurement data to the control device 22. The control device 22 controls an output of the thermal power plant 23 which exists within the power grid.

When it is judged from the measurement data sent from the monitor device 21 that the large-scale renewable power generator 20 decreases in output power, the control device 22 controls this output variation in such a way as to reduce the output of the thermal power plant 23. When it is judged from the measurement data sent from the monitor device 21 that the renewable power generator 20 increases in output, the control device 22 controls the output variation in a way as to increase the output of the thermal power plant 23.

In this way, the output variation of large-scale renewable power generator 20 is lowered by providing control to reduce or increase the output of the thermal power plant 23 in accordance with a decrease or increase in output of the large-scale renewable power generator 20.

The monitor device 21 is monitoring a present capacity of the virtual secondary battery 24. The remaining variation is absorbed by the power demanding device 15 and the virtual large-size battery 17, thereby making it possible to control main variation to the extent that no influence is exerted on the power grid.

According to the embodiment 3, it is possible to reduce the secondary battery capacity required for absorption of variations of the renewable energy-derived electrical power capable of being supplied to anywhere in a city, thereby enabling removal of output variations. Thus, it becomes possible to stably supply electric power. Especially, installation of a new secondary battery is not needed. This makes it possible to leverage as a virtual large-size battery an aggregation of residual capacities of the secondary batteries as have been set forth in the embodiment 2.

It should be further understood by those skilled in the art that although the foregoing description has been made on embodiments of the invention, the invention is not limited thereto and various changes and modifications may be made without departing from the spirit of the invention and the scope of the appended claims.

1. A grid operation method using a secondary battery, said method comprising the steps of:
causing a control device to receive measurement data to be sent from a monitoring device operative to measure an output of a renewable energy power generation apparatus in a house and a variation of the output thereof; and
causing the control device to allot the output variation to each home-use electrical equipment in the house and decrease or increase a preset temperature of the home-use equipment to thereby control the output variation of the renewable energy power generation apparatus while absorbing a remaining output variation by charging and discharging of the secondary battery.

2. A grid operation method using secondary batteries, said method comprising the steps of
gathering residual electricity storage amounts of the secondary batteries for managing them as a virtual battery;
upon receipt of measurement data sent from a second monitoring device which measures an output and an output variation of a large-scale renewable power generation apparatus including a wind power generator, allotting the output variation to electrical power demand machines installed in buildings, factories and large warehouses; and
controlling preset temperatures of the power demand machines to control output variations of the large-scale renewable power generation apparatus while absorbing remaining output variations by charge and discharge of the virtual battery.

3. A grid operation method using secondary batteries, said method comprising the steps of:
letting a control device receive measurement data to be sent from a monitoring device operative to measure an output and an output variation of a renewable power generation apparatus including a wind power generator; and
letting the control device control an output of a thermal power generation facility to thereby control the output variation of the renewable power generation apparatus while absorbing a remaining output variation by charge and discharge of a virtual secondary battery storing therein residual electricity storage quantities of those secondary batteries connected to electric power demanding devices placed in buildings, factories and large warehouses.

4. A grid operation method using a secondary battery for use in an electricity distribution system of a house having a renewable power generation apparatus, said system including a home-use electrical equipment in the house, a secondary battery of an individual house or a separately central-managed secondary battery system, and a control device for measuring an output variation of the renewable power generation apparatus and for controlling the output variation, said method comprising the steps of:
absorbing to a maximum extent an output variation of a house-oriented small-scale renewable power generation apparatus occurring due to changes in time and weather and changes of seasons by preset temperature control of home-use electric equipment, which is free from a risk of losing convenience of life due to a short time change; and
absorbing remaining variations by charge and discharge of the secondary battery.

5. A grid operation method using a secondary battery for use in a system including electric power demanding devices within demand-side structures which are larger in scale than houses, such as buildings, factories and large warehouses, a secondary battery of individual house or a separately central-managed secondary battery system, and a control device which measures an output variation of renewable power generation apparatus and controls the output variation, said method comprising the steps of:
absorbing, to a maximum extent, an output variation of a renewable power generation apparatus installed in an electrical power transmission/distribution system occurring due to changes in time and weather and changes of seasons by preset temperature control of the power demanding devices of buildings, factories and large warehouses, the machines being free from a risk of losing convenience of life by a short time change; and
absorbing a remaining variation by charge and discharge of a virtual large-size secondary battery utilizing a plurality of power storage capacities to thereby absorb variations of the large-scale renewable power generation apparatus interconnected to the power transmission/distribution system.

6. A grid operation method using a secondary battery for use in an electrical power transmission system having a large-scale renewable power generation apparatus capable of supplying electric power to a group of houses and a plurality of buildings, factories, large warehouses and others, said system including a thermal power generation station, a virtually central-managed secondary battery, and a control device operative to measure an output variation of a renewable power generation apparatus and control the output variation, said method comprising the steps of:
absorbing, to a maximum extent, output variations of the renewable power generation apparatus installed in the power transmission system occurring due to changes in time and weather and changes of seasons by adjustment of an output of thermal power generation; and
absorbing remaining variations by using a plurality of power storage capacities and by leveraging them as a virtual large-size battery to thereby absorb variations of the large-scale renewable power generation apparatus interconnected to the power transmission system.
